(19) United States
(12) Patent Application Publication
(10) Pub. No.: US 2014/0236796 A1
(43) Pub. Date: Aug. 21, 2014

(54) SYSTEM AND METHOD FOR EVALUATING FINANCIAL TRADING STRATEGIES

(71) Applicant: Tradeslide Ventures Ltd., London (GB)

(72) Inventors: Javier Colón Bolea, Madrid (ES); Fernando Savirón, Madrid (ES)

(73) Assignee: Tradeslide Ventures Ltd., London (GB)

(21) Appl. No.: 14/182,779

(22) Filed: Feb. 18, 2014

Related U.S. Application Data
(60) Provisional application No. 61/766,409, filed on Feb. 19, 2013.

(51) Int. Cl. G06Q 40/04

(52) U.S. Cl. CPC G06Q 40/04
USPC 705/37

(57) ABSTRACT

A method for evaluating a financial trading strategy includes at least one computing device receiving a trade record comprising a sequence of trades. The method further includes determining, by the at least one computing device, performance parameters associated with the trades, wherein at least some performance parameters are based on financial data captured at a time other than a time of execution of the trades. The method further includes calculating, by the at least one computing device, a performance score of the trade record based on the performance parameters.

### TECHNICAL FIELD

This disclosure is generally related to methods, systems and apparatus for evaluating and ranking financial trading strategies, and more particularly to methods, systems and apparatus for predicting future success (e.g., risk-adjusted profitability) of financial trading strategies based on granular trade-level analysis and assessment of historic investment decisions, including the circumstances, basis and conditions surrounding such decisions.

### BACKGROUND

Recently, the number of alternative speculators in financial markets has increased exponentially. The most talented financial speculators succeed at extracting non-random profits from sufficiently liquid markets. This represents an opportunity for investors, provided they're offered better than random indicators on the basis of which to identify candidate strategies to replicate. Consequently, investors need a way to adequately incorporate all available information in order to select which financial trading strategy they want to implement. Current methodologies and solutions for evaluating financial trading strategies do not incorporate granular, trade-level information into the assessment of financial trading strategies; nor are they capable of determining a risk-adjusted performance of said financial trading strategies. More particularly, current methods and systems fail to assess or even contemplate examining factors indicative of the “what” and “how” of historic investment decisions of financial trading strategies, such as trade-level risk taking, frequency of trades, duration of trades, prevailing market conditions at the time trading decisions are being made, etc. when evaluating individual trading decisions of trading strategies involving equities, futures (e.g. equity, commodities, fixed income), rolling spot foreign-exchange contracts, contracts for differences (e.g. index, individual stock, commodities), or any other financial instrument.

Currently, the methods used to evaluate performance by financial trading strategies are limited to measuring ex-post returns (or losses), without evaluating the individual trading decisions that led to the returns and/or losses. As such, these methods ignore information that may be valuable in predicting future performance.

For example, some financial institutions apply well-known metrics such as the Sharpe-ratio or Sortino ratios in an attempt to determine profitability. These measures, however, are not suited to assessing investment strategies that are based on a frequent rotation of leveraged investments over short or very-short holding periods (e.g., seconds, minutes, hours and days). In particular, these measures fail to incorporate valuable, granular trade level insights relating to how a measured performance was achieved by focussing exclusively on what performance was achieved, and in addition ignoring trade level profitability insights.

Thus, there is a need for methods, systems and apparatus capable of evaluating financial trading strategies that involve leveraged assets by tracking and measuring past investment decisions, the circumstances surrounding those decisions, and how those decisions came about (i.e., the basis of such decisions) in order to predicted future performance (e.g., risk-adjusted profitability). There is also a need to utilize more than mere ex-post return data to determine future performance of trading strategies. In addition, there is a need for determining a standardized, investor oriented performance rating suitable for comparing the performance of different trading strategies, irrespective of the underlying financial assets traded, on an ‘apples-to-apples’ basis, from a rational investor's standpoint.

### SUMMARY

The present disclosure relates generally to methods, systems and apparatus for evaluating financial trading strategies. In one embodiment, a method for conduct an exchange auction may be implemented via at least one computing device. This computing device may be configured to receive one or more trade records, each comprising a sequence of trades. The computing device may be configured to determine one or more performance parameters associated with the trades, where some performance parameters may be based on financial data captured before, after or at a time of execution of the trades in the sequence of trades. The computing device may then be configured to calculate an overall performance score for the trade record based on a culmination of the performance parameters.

In another embodiment, a system for conducting an exchange auction may comprise one or more computing devices comprising one or more processors and memory storing computer-readable instructions. These computing devices may be in communication with each other via one or more wired and/or wireless networks. In this exemplary embodiment, the system may be configured to receive one or more trade records (each comprising a sequence of trades), assess the trades in the trade records, and determine one or more performance parameters associated with the trades. The performance parameters may be based on financial data pertaining to a time period that is before, during and/or after execution of any particular trade. Then, based on the results of the performance parameters of the respective trades, the system may calculate an overall performance score for each trade record that may be utilized to determine the relative performance of the trade records.

### BRIEF DESCRIPTION OF THE DRAWINGS

The foregoing summary and the following detailed description may be better understood when read in conjunction with the appended drawings. Exemplary embodiments are shown in the drawings, however, it is to be understood that the embodiments are not limited to the specific methods and instrumentalities depicted herein. In the drawings:

FIG. 1A is a sequence diagram illustrating an exemplary method for evaluating a plurality of financial trading strategies in accordance with the present disclosure;

FIG. 1B is a sequence diagram illustrating an exemplary process for combining financial positions associated with one of the financial trading strategies being evaluated according to FIG. 1A; and

FIG. 2 is a diagram illustrating an exemplary system for evaluating a plurality of financial trading strategies in accordance with the present disclosure.

### DETAILED DESCRIPTION

The present disclosure relates generally to methods, systems and apparatus for evaluating the performance of financial trading strategies involving leveraged assets. This may be accomplished, for example, by tracking and measuring past investment decisions, the circumstances surrounding those decisions, and how those decisions came about in order to generating performance scores that are predictive of future performance of the financial trading strategies. In generating the performance scores, the present disclosure may consider any number of individual investment decisions (up to all investment decisions), as well as prevailing market conditions around and between the investment decisions, associated with the financial trading strategies. Once generated, the performance scores may be used to assess the relative performance of financial trading strategies. Indeed, since the performance scores may be standardized, the performance scores may provide potential financial investors seeking risk-adjusted profits with a standardized (“apples-to-apples”) comparison of the performance of the financial trading strategies, even if the financial trading strategies involve different assets, activity patterns (frequency and duration of trades) and risk levels. Further, by considering pertinent information available prior to, during and after the time various investment decisions are being made, the present disclosure reduces uncertainty associated with the predicted outcome of the investment strategies.

To that end, the present disclosure provides new methods, systems and apparatus for evaluating financial trading strategies that take into account individual investment decision(s), as well as prevailing market conditions around and between investment decisions, associated with the financial trading strategies. In addition, the present disclosure provides means for standardizing performance measure(s) of alternative financial trading strategies (e.g., strategies involving different assets, activity patterns (frequency and duration of trades) and risk levels), to enable users to easily compare competing financial trading strategies and assess their risk-adjusted profit potentials. The present disclosure also provides means for diagnosing financial trading strategies for key early predictors of long term, risk adjusted performance, including risk, changes to risk, flags for loss aversion and discipline. Further, in one particular aspect, the present disclosure provides means for comparing financial trading strategies involving different combinations of spot contracts, rolling spot foreign exchange contracts and exchange quoted futures on the same assets with a homogeneous, risk adjusted measures.

For purposes of this disclosure, the following terms shall be given the following meanings.

The term “computer” or “computing device” shall refer to any electronic and/or communication device or devices, including those having capabilities to be utilized in connection with a financial strategy evaluation system, such as any device capable of receiving, transmitting, processing and/or using data and information. The computer or computing device may comprise a server, a processor, a microprocessor, a personal computer, such as a laptop, palm PC, desktop or workstation, a network server, a mainframe, an electronic wired or wireless device, such as for example, a telephone, a cellular telephone, a personal digital assistant, a smartphone, an electronic pager or any other computing and/or communication device.

The term “strategy evaluation server” shall refer to an exemplary type of a computer or computing device. The strategy evaluation server may comprise one or more processors configured to execute instructions stored in a non-transitory memory. The strategy evaluation server may be configured for receiving financial trade strategy data and information defining sequence(s) of trade(s) and market data, and for evaluating financial trade strategies based on the received data and information. The strategy evaluation server may be embodied in a single computing device, while in other embodiments, a strategy evaluation server may refer to a plurality of computing devices housed in one or more facilities that are configured to jointly provide local or remote computing services to one or more users or user devices. The strategy evaluation server may send and receive data from user devices, data servers, or any other type of computing devices or entities over the Internet, over a Wi-Fi connection, over a cellular network or via any other wired or wireless connection or network known in the art.

The term “network” shall refer to any type of network or networks, including those capable of being utilized in connection with a financial stagey evaluation system, such as, for example, any public and/or private networks, including, for instance, the Internet, an intranet, or an extranet, any wired or wireless networks or combinations thereof.

The term “financial asset” shall refer to any type of financial instrument, such as, without limitation, stocks, options, commodities, derivatives, shares, bonds, currencies, indices, equities, equity futures, commodity futures, fixed income futures, spot contracts, exchange quoted futures, rolling spot foreign-exchange contracts, contracts for differences (index, stock, and commodities), or any other type of financial instruments known in the art.

The term “trade” shall refer to any type or part of a transaction or exchange (such as a purchase and/or sale) that may occur in connection with one or more financial assets.

The term “trade turnaround” shall refer to an investment in a single financial asset purchased at an open price at an opening time, and sold at a closing price at closing time. In one embodiment, the trade turnaround may be defined by an opening trade when a financial asset is purchased and a later closing trade when the financial asset is sold. The duration of the trade turnaround maybe defined by a length of time spanning the opening and closing trades (“the trade turnaround period). The financial asset may be considered “at risk” for the duration of the trade turnaround period.

The term “timestamp” shall refer to an exact point in time at which a trade (such as an opening trade or closing trade of a trade turnaround) is executed.

The term “financial trading strategy” shall refer to any type of investment activity that involves initiating at least one trade (e.g., financial transactions) by an investor over a period of time. For example, the investment activity defining a financial trading strategy may include a sequence of speculation trade(s) that are based on making risk-based investment(s) that are held for a relatively short period of time (e.g., ranging from one or seconds up through several months or longer, or any other desired holding period). A financial trading strategy may also include a plurality of trade turnarounds occurring in succession, with overlaps or simultaneously.

The term “combined position” shall refer to a combination of all financial assets that are placed at risk by trade turnarounds of a given financial trading strategy between two given timestamps.

The term “market risk” shall refer to a risk to equity positions for an investor in a financial trading strategy as a consequence of adverse changes in the market price of financial assets associated with the trade turnarounds of the financial trading strategy.

The term “performance parameter” shall refer to any score, assessment or appraisal that may be used to evaluate an investment decision (e.g., a trade) of a financial trading strategy.

The term “market data” shall refer to any financial data related to live or historical market conditions and prices as well as any other type of data and information that may be relevant to trading or inventing. Market data may comprise market attributes of at least one financial asset. For example, market data may comprise price data, volume data or any other relevant financial data related to a financial asset. Market data may also comprise any type of relevant financial information, such as depth of market, prevailing interest rates, etc.

The term “leverage” shall refer to a nominal of a trade divided by equity of the trader. Leverage may be used when an excess of nominal above equity is borrowed on margin by a trader from his broker or prime broker, thus amplifying the impact of volatility of the gains and losses of the trade.

### Financial Strategy Evaluation Process Overview

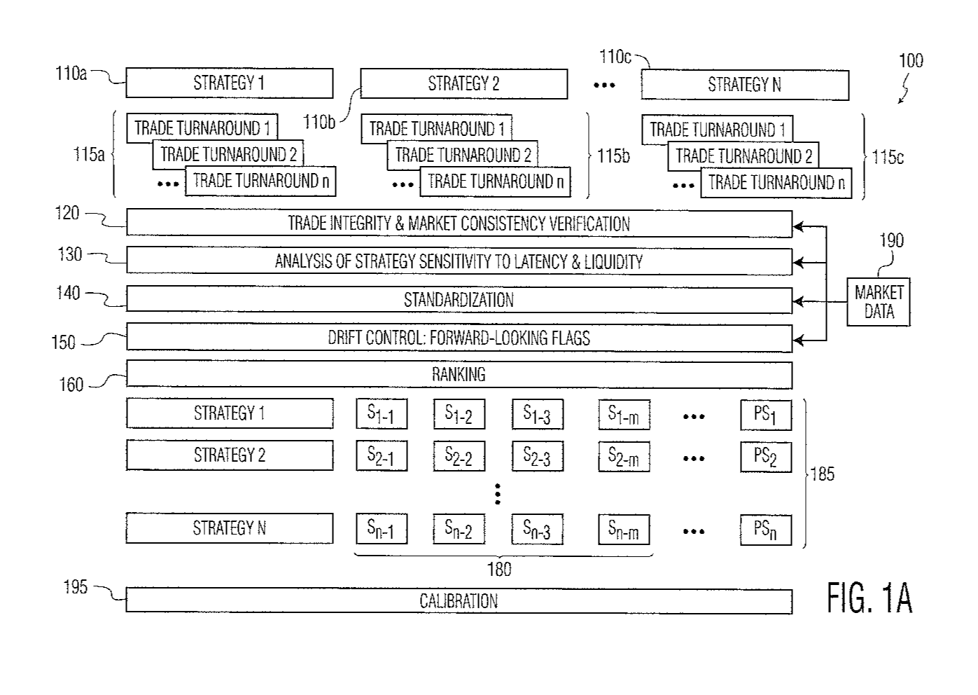

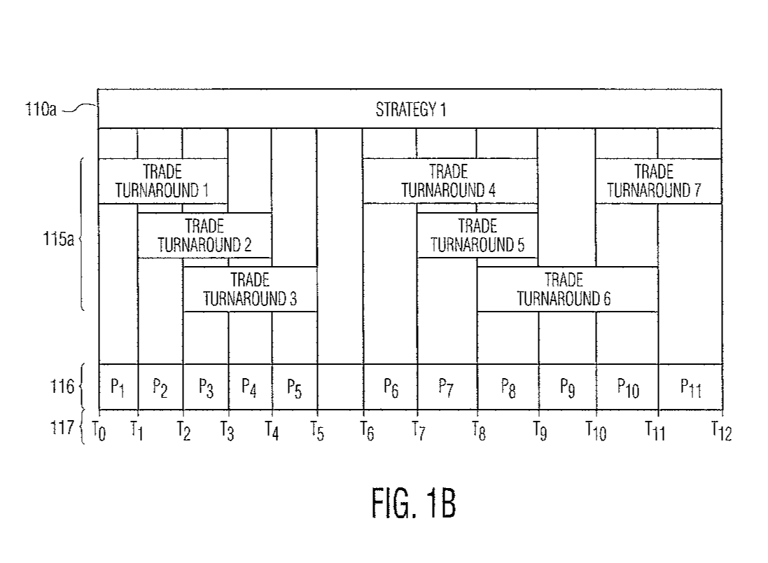

Turning now to FIG. 1A, an exemplary method 100 for evaluating financial strategies in accordance with the present disclosure is shown. The exemplary method 100 of FIG. 1A demonstrates an exemplary sequence of steps performed by a strategy evaluation server and/or any other properly configured computing device(s). The strategy evaluation server may comprise one or more computing devices that include non-transitory memory for storing instructions and one or more processors for executing the instructions to perform the steps of the illustrated method 100.

As an initial step, the strategy evaluation server may receive a plurality of financial trading strategies 100a, 100b, 100c from traders or investors who may submit their strategies for evaluation via one or more trader (computing) devices. For example, the strategy evaluation server may receive strategies 1 through N (110a, 110b, 110c). Each of the strategies 110a, 110b, 110c may comprise a sequence of trades defining the trade turnarounds 115a-c of each of the financial trading strategies 110a, 110b, 110c. For example, strategy 110a may comprise a sequence of trades that define multiple trade turnarounds 115a, strategy 110b may include trades defining trade turnarounds 115b, and strategy 110c may include trades defining trade turnarounds 115c. In other embodiments, the strategy evaluation server may receive an arbitrary number of financial trading strategies, each including any number of trades and trade turnarounds.

Each trade turnaround 115a-c may be associated with a financial asset, and include timestamps defining the time of execution of both the opening trade and the closing trade of each trade turnaround. In one embodiment, each trade turnaround may also define the exact financial asset that was bought and sold, the quantity of that financial asset, the Leverage of each trade, and other trade related data and information.

### Verification of Internal Consistency and of Prevailing Market Conditions

Next, at step 120, the strategy evaluation server may assess trade integrity, determine internal market consistency and verify prevailing market conditions of trades included in a particular financial trading strategy (110a, 110b, 110c). For every trade in a sequence of trades (115a-c) of a particular financial trading strategy 110a-c, the strategy evaluation server may normalize each trade's timestamp (e.g., to GMT (Greenwich Mean Time) time). The strategy evaluation server may further receive market data 190 for every financial asset associated with the financial trading strategies 110a-c. For example, the market data 190 may comprise price information of the financial assets traded by the trade turnarounds 115a-c before, after and during the timestamps of the trade turnarounds 115a-c. The market data 190 may also comprise financial rates, market conditions data, depth-of-book data or any other type of financial data and information known in the art. The market data 190 may be received by the strategy evaluation server from open market sources, private market sources, internal sources, and an external market data server or from any other source.

The strategy evaluation server may then compare the reported execution price of every trade of the sequence of trades of the financial trading strategies 110a-c with the prevailing market prices at the time defined by trades' timestamps. The strategy evaluation server may then automatically flag execution prices that are outside of a predefined tolerance interval. The strategy evaluation server may also automatically flag any detected systematic bias in reported execution prices if it is statistically significant at a target confidence level.

The strategy evaluation server may evaluate the interval market consistency of each financial trading strategy 114a-c in order to determine if the equity changes reported by the financial trading strategy could be achieved by the reported trade turnarounds 115a-c. The strategy evaluation server may reconstruct reported equity balance for every financial trading strategy 110a-c based on the corresponding reported trade turnarounds 115a-c using received market data 190 for prevailing landing rates. The strategy evaluation server may flag deviations of the estimated equity balance from the reported balance as a possible indication of fraud. The strategy evaluation server may also analyze systematic bias in favor of each of the financial trading strategies 110a-c and flag statistically significant deviations at a target confidence level.

### Calculating Market Liquidity and Transmission Latency Performance Parameters

Next, the strategy evaluation server may conduct an analysis of financial trade strategies sensitivity to latency and liquidity at step 130 to calculate the market liquidity and transmission latency performance parameters using the received market data 190.

For example, in order to evaluate the transmission latency of each of the financial trading strategies 110a-c, the strategy evaluation server may conduct the following process for every timestamp of every trade of the financial trading strategies 110a-c. For every trade, the strategy evaluation server may record the execution price of the trade's financial asset at the time defined by the timestamp (time t) of that trade. The strategy evaluation server may further record the price of that financial asset at a time t+Δt (where Δt is a predefined time delay). Next, the strategy evaluation server may record the price of the financial asset at a time t+2Δt. The strategy evaluation server may also record the price of the financial asset at other arbitrary time points defined by the formula t+NΔt (where N is an arbitrary integer).

Next, the strategy evaluation server may construct a slipped price distribution based on the differences between the recorded prices of the financial asset. The slipped price distribution may reflect the fact that if an investor would try to replicate one or more of the financial trading strategies being evaluated with latency and leverage, he would experience random deviations to the performance that would correlate with the volatility of the price of the financial asset. Consequently, the strategy evaluation server may assign lower market liquidity performance scores to the financial trading strategies 110a-c that exhibit high variations in the constructed slipped price distribution.

In order to evaluate the market liquidity associated with each of the financial trading strategies 110a-c, the strategy evaluation server may conduct the following process for every timestamp of every trade of the financial trading strategies 110a-c. For every trade, the strategy evaluation server may record the execution price of a financial asset at the time of that trade's timestamp. The strategy evaluation server may then record a plurality of hypothetical execution prices of the financial asset for increasing multiples of volume (i.e., volume thresholds) of the trade. The hypothetical execution prices may be calculated based on the depth-of-book historical information data contained in the received market data 190. For example, if the original trade had a volume of 1,000, the hypothetical execution prices may be calculated and record for hypothetical trades with a volume 2,000, 3,000 and/or other multiples of 1,000.

The strategy evaluation server may then construct an elasticity curve based on the differences between hypothetical execution prices at each of the volume thresholds described above. The strategy evaluation server may assign lower evaluation scores to financial trading strategies 110a-c that exhibit larger price/volume elasticity of the traded asset(s). Thus, the market liquidity measure performance parameter may penalize strategies involving illiquid assets, since replicating such financial trading strategies is likely to result in inferior performance by investors replicating the strategy with significantly higher volumes than those of the original strategy.

### Standardization of Trades

Next, the strategy evaluation server may determine a plurality of combined positions for each of the financial trading strategies 110a-c. FIG. 1B shows an exemplary process 100B for determining the combined positions 116 (labeled P1 through P11) of an exemplary financial trading strategy (Strategy 1) 110a. The exemplary financial trading strategy 110a may comprise a plurality of trade turnarounds 115a, where each trade turnaround may be defined by a purchase of a financial asset and a sale of that financial asset at a later time. A financial turnaround 115a may also be defined as a borrowing of a financial asset at a price X at a time A and returning that financial asset at a lower price Y at a later lime B, thus generating a positive profit for the borrower. The exemplary financial trading strategy 110a comprises seven (7) trade turnarounds (trade turnaround 1-trade turnaround 7), however it should be understood that the financial trading strategy 110a may comprise any number of trade turnarounds.

The strategy evaluation server may divide the duration of the financial trading strategy 110a by a plurality of timestamps 117, creating several time periods. For example, timestamps T₀ though T₁₂ (117) may divide the duration of the financial trading strategy 110a into eleven (11) consecutive time periods, each having a duration defined by two consecutive timestamps 117. For example, a first time period may be defined as the duration between timestamp T₀ through T₁, a second time period may be the duration between timestamp T₁ through T₂, and so on. However, it is to be understood that any number of timestamps creating any number of time periods may be used in accordance with this disclosure. In one embodiment, the time periods may all have a standardized duration, as described below. For each time period, the strategy evaluation server may calculate the combined positions (P1 though P11) 116 based on the trade-turnarounds that are open during each respective time period. For example, the calculated combined positions P2 may be based on positions defined by trade turnaround 1 and trade turnaround 2, while the combined position P3 may be based on positions defined by turnaround 1, trade turnaround 2, and trade turnaround 3. Notably, it is possible for certain time periods to be devoid of any combined positions. For example, since there are no trades or trade turnarounds during the time period defined by timestamps T₅ and T₆, there are no positions to combine during this time period. As a result, this time period (between timestamps T₅ and T₆) may have no associated combined position value. Each of the combined positions 116 may represent a composite asset whose properties depend on the volatility of the individual financial assets traded by the respective turnarounds, the relative weight of each financial asset in the combined position 116, and the correlation between the assets traded.

Returning now to FIG. 1A, the strategy evaluation server may transform each combined position (P1-P16 from FIG. 1B) defined by each of the sequence of trade turnarounds 115a-c into standardized positions at step 140. The standardized positions produced during the standardization step 140 may be effectively compared, since this standardization step 140 transforms the positions into comparable positions for statistical significance across any two of the financial trading strategies 110a-c, regardless of their individual properties. The strategy evaluation server may base the position standardization 140 on: the duration(s) of the time period(s) of the financial trading strategy when a financial asset is placed at risk by the trade turnarounds of that strategy, including the time periods when a plurality of financial assets are placed at risk; recently observed volatility of those financial assets; recently observed correlations between financial assets placed at risk at the same time, correlated leverage of the positions, market-to-market value of equity on a continuous basis for each position; and time periods when no financial assets are placed at risk.

As indicated above, the strategy evaluation server may also standardize the time periods during which positions are combined for each of the financial trading strategies 110a-c. Standardizing these periods may be particularly important for financial trading strategies involving trades that are associated with spot contracts for differences (CFDs), foreign exchange, or exchange traded futures, for example. Standardizing the time periods may be based on one or more of the following factors: absolute risk time length, adjusted risk time length and an absolute number of trade turnarounds. The absolute risk time length may be defined as an overall length of time during which financial assets are placed at risk, calculated by adding all non-simultaneous time-windows with open trade turnarounds. The adjusted risk time length may be defined as a length of time when financial assets are placed at risk, weighted by leverage, discounting simultaneous trades for positive correlation between the traded assets. The absolute number of trade turnarounds may be defined as an absolute number of trade turnarounds of a financial trading strategy, after application of a correction factor that penalizes simultaneous trade turnarounds in financial assets with high positive correlation to each other. In one embodiment, the standardized periods may roughly correspond to 22 trading days (one trading month) of continuous operation by an active financial trading strategy.

In addition, the strategy evaluation server may calculate a standardized risk performance parameter for each of the financial trading strategies 110a-c as part of the standardization step 140. Calculation of the standardized risk performance parameter may be particularly relevant for financial trading strategies involving trades that involve leverage, such as with spot CFDs, foreign exchange, or exchange traded futures, just to name a few. The standardized risk performance parameter may be determined based on a bi-variate distribution with two independent variables: 1) a distribution of mark-to-market value of equity when a financial asset is placed at risk by a financial trading strategy; and 2) a proportion of time during the financial trading strategy where no equity is at risk. For every financial trading strategy 110a-c, for any given evaluation period, the standardized risk performance parameter may track how much risk is incurred when equity is placed at risk, as well as the proportion of theoretical trading time where risk is open. A bi-variate distribution at any target confidence interval may be projected at 1 calendar month. The standardized risk performance parameter may be used to assign any of the financial trading strategies 110a-c to one of any number of risk buckets (e.g., seven risk buckets) at a 95% confidence interval, over a 1-month period.

The strategy evaluation server may also optionally calculate a standardized performance parameter for each of the financial trading strategies 110a-c. The standardized performance parameter may be defined as a non-random performance per unit of standardized risk measure, over a set time interval (e.g., from inception, last month, etc.). The strategy evaluation server may calculate raw performance of a financial trading strategy according to the following formula (Equity Value₍ₜ₎−Equity Value₍ₜ₋₁₎)/Equity Value₍ₜ₋₁₎ where Equity Value₍ₜ₎ is the value of equity of a trading strategy at the beginning of the set time interval, and Equity Valueₜ₋₁ is the value of the equity at the end of the set time interval.

The strategy evaluation server may then conduct a random performance test by calculating raw performance for the same time period for a plurality (e.g. 10,000) of alternative simulated financial trading strategies with volatility, leverage and duration distributions comparable to the financial trading strategy that is being evaluated. The strategy evaluation server may also conduct a random leverage test by calculating raw performance for the same time period for a plurality (e.g. 10,000) of alternative simulated financial trading strategies with leverage for all trades set at a constant level equal to the average leverage of the financial trading strategy that is being evaluated. The strategy evaluation server may then calculate an adjusted standardized performance parameter of the financial trading strategy based on the results of the raw performance determination, the random performance test, the random leverage test and the calculated standardized risk of the financial trading strategy.

### Drift Control: Forward Looking Flags

Once the standardization step 140 is complete, the strategy evaluation server may conduct a drift control evaluation by evaluating and flagging several forward looking performance measures 150 of the financial trading strategies 110a-c based on the trade turnarounds 115a-c and received market data 190 at step. Optionally, one or more of these (forward looking) performance parameters may be calculated as a part of drift control analysis. For example, the performance parameters may include (without limitation): a consistent leverage parameter, a stable risk parameter, a loss aversion parameter, exit and an entry parameters and discipline parameter.

### Calculation of the Consistent Leverage Parameter

The consistent leverage parameter for each of the financial trading strategies 110a-c may be calculated by first calculating one or more of the following values for each trade turnaround 115a-c: a nominal leverage at which each turnaround is opened, a volatility of the financial asset associated with each turnaround, and a duration of each trade turnaround. This information may then be used to create a scatter-plot, for example, for each of the trade turnaround, where one axis corresponds to the duration of the trade turnaround and the other axis corresponds to the product of the calculated nominal leverage and the calculated volatility of the financial asset.

The strategy evaluation server may also plot notional volatility/duration curves corresponding to each of the standard risk buckets. The strategy evaluation server may then calculate the consistent leverage performance parameter by analysing the dispersion of the scatter-plots of each of the financial trading strategies 110a-c around the average standardized risk of each financial trading strategy in that time period. The presence of trade turnarounds that are outside of a predetermined tolerance interval may result in a decrease of the consistent leverage performance parameter for that financial trading strategy, where dispersion on turnarounds with longer duration is penalized disproportionately higher than dispersion on short turnaround times. The accuracy of the fit of commercially available risk curves to a particular scatter plot may also be used as a diagnostic flag for a non-structured approach to risk management of a given financial trading strategies. The strategy evaluation server may also rank consistent leverage performance parameters of the financial trading strategies 110a-c by degrees of dispersion around their own average standardized risk measures.

### Calculation of Stable Risk Performance Parameter

The strategy evaluation server may calculate the stable performance parameter for each of the financial trading strategies 110a-c to determine a deviation of risk of each strategy 110a-c from historical patterns. For each of the financial trading strategies 110a-c, the strategy evaluation server may calculate a rate of standardized risk per standardized time period. The strategy evaluation server may then calculate fluctuations of the standardized risk across one or more consecutive standardized time periods. The rate of change of standardized risk across consecutive standardized time periods may then be assessed and the strategy evaluation server may assign a higher stable risk performance parameter score to trading strategies 110a-c that display a low rate of change of standardized risk across consecutive standardized time period, low volatility of the standardized risk compared to the average standardized risk within each standardized time period, and low rate of change of standardized risk within and across standardized time periods.

### Calculation of Loss Aversion Performance Parameter

The strategy evaluation server may calculate the loss aversion performance parameter for each of the financial trading strategies 110a-c to detect cognitive bias resulting from loss aversion of the trader. This may be accomplished by calculating values of a maximum favorable excursion measure and a maximum adverse excursion measure for each trade turnaround 115a-c of each of the financial trading strategies 110a-c. The maximum favorable excursion measure may be calculated using the following formula: (maximum market price of a financial instrument during the trade turnaround−price of a financial instrument at the opening of the trade turnaround)/(price of a financial instrument at the opening of the trade turnaround). The adverse excursion measure may be calculated using the following formula: (minimum market price of a financial instrument during the trade turnaround−price of a financial instrument at the opening of the trade turnaround)/(price of a financial instrument at the opening of the trade turnaround).

The strategy evaluation server may then calculate a trade bias value for each trade turnaround 115a-c defined by the financial trading strategies 110a-c by using the following formula: Absolute Value of (favorable excursion measure/adverse excursion measure). A histogram of trade bias values for all trade turnarounds 115a-c in any given standardized time period for the financial trading strategy being rated may then be created for the strategies being evaluated. The strategy evaluation server may use the histograms to tracks statistically significant deviations of calculated trade bias values from a target value of 1, for example. Such deviations may be an indicator of loss aversion, a well-established phenomenon in behavioural finance whereby traders fear a loss of a certain size and probability more than they cherish a win of equal size and probability. The strategy evaluation server may consequently assign lower loss aversion performance parameter scores to financial trading strategies that show large deviations.

### Calculating Optimal Exit and Entry Performance Parameter

The strategy evaluation server may calculate an optimal exit and entry performance parameter for each of the financial trading strategies 110a-c to detect systematic underperformance of trade timing choices vs. alternative opportunities. This may be accomplished by performing the following steps for one or More of the trade turnaround 115a-c of the trading strategy 110a-c that is being evaluated. The duration of a trade turnaround 115a-c may be marked with a number of time nodes (e.g., 11) that break down this duration into a predefined number of time windows of equal length (e.g., 10). The time nodes may be labelled t₀ through t₁₀ respectively, for example, where t₀ denotes the time when a trade turnaround is opened, and t₁₀ denotes the time when the trade turnaround is closed. Additional “past” time nodes may be created to define past time windows immediately preceding the opening of the trade turnaround. The length of these past time windows defined by these past time nodes may be equal to that of the original time windows. The past time nodes may be labelled t₋₅-t₋₁, for example. Similarly, additional “future” time nodes may be created to define future time windows immediately after the closing of the trade turnaround. The length of these future time windows defined by these future time nodes may equal to that of the original time windows. These future time nodes may be labelled t₁₁-t₁₅, for example.

The strategy evaluation server may then calculate a prevailing market price of a financial instrument associated with the trade turnaround 115a-c for each time window defined by nodes t₋₅-t₁₅. The strategy evaluation server may then create an entry ranking, by sorting the time nodes L₅-t₅ by associated descending prevailing market prices. The strategy evaluation server may also create an exit ranking, by sorting the time nodes t₅-t₁₅ by descending prevailing market prices.

Next, strategy evaluation server may calculate an entry rank value by calculating the relative rank of node t₀ in the entry ranking, and an exit rank value by calculating the relative rank of node t₁₀ in the exit ranking.

Then, the strategy evaluation server may calculate the entry ratio value by calculating the ratio of ((Pt₀−Ptₘᵢₙ)/(Ptₘₐₓ−Ptₘᵢₙ) as a percentage, where Pt₀ is the price of the financial asset at t₀, Ptₘᵢₙ is a minimum price in the entry ranking, and Ptₘₐₓ is a maximum price in the entry ranking.

The exit ratio may be calculated by calculating the ratio of ((Pt₁₀−Ptₘᵢₙ)/(Ptₘₐₓ−Ptₘᵢₙ) as a percentage, where Pt₁₀ is the price of the financial asset at t₁₀, Ptₘᵢₙ is a minimum price in the exit ranking, and Ptₘₐₓ is a maximum price in the exit ranking.

Next, the optimal entry performance parameter may be calculated by plotting a dual distribution of calculated entry rank values and entry ratio values for every trade turnaround of the financial trading strategy 110a-c that is being evaluated. The optimal entry performance parameter may reflect the quality of trading decisions at the point of entry, and take into account several key aspects of the strategy. For example, the optimal entry performance parameter may evaluates and/or indicate whether a strategy manager is opening his trades timely and whether there is a pattern for target entry points for both winning and losing trades. The optimal entry performance parameter may reward financial trading strategies that display evidence of patterns (e.g., by yielding a higher performance score) because strategies that are good at choosing trade turnaround opening points may often be strategies that are more likely to have identifiable recurring patterns in the market price of traded financial assets.

The strategy evaluation server may then calculate the optimal exit performance parameter by plotting a dual distribution of calculated entry rank values and entry ratio values for trade turnarounds of the financial trading strategy 110a-c that is being evaluated. The optimal exit performance parameter may reflect the quality of trading decisions at the point of exit, and may take into account several key aspects of the financial trading strategy 110a-c. The optimal entry performance parameter may evaluate and/or indicate whether a strategy manager is closing his trades timely, whether there is a pattern for target entry points for both winning and losing trades and/or whether the strategy manager implementing consistent take-profit and stop-loss rules, for example. The optimal exit performance parameter may reward financial trading strategies that display evidence of patterns (e.g., by yielding a higher performance score) because strategies that are good at choosing trade turnaround closing points may often be strategies that are more likely to have identified recurring patterns in the market price of traded financial assets.

### Calculating Discipline Performance Parameter

A discipline performance parameter for each of the financial trading strategies 110a-c may also be determined, to analyse and assess a consistency of new trades for a given financial trading strategy 110a-c against historical implementation(s) of that particular strategy. This may be accomplished, for example, by performing the following steps for each trade turnaround 115a-c of the trading strategy 110a-c that is being evaluated. First, the strategy evaluation server may calculate a Win/Loss percentage by using the following formula: ((Close Price−Open Price)/(Open Price))−1, where Open Price represents the price of a financial asset associated with a trade turnaround at a time when trade turnaround is opened, and where Close Price represents the price of the financial asset when trade turnaround is closed. Next, the strategy evaluation server may calculate the Absolute Price Win/Loss by using the following formula: (Close price−Open price). The strategy evaluation server may then retrieve Pₘₐₓ and Pₘᵢₙ values (e.g., via a market data source 190), where Pₘₐₓ is the maximum price for the financial asset during the duration of the trade turnaround, and Pₘᵢₙ is the minimum price for the financial asset during that same period. Next, the strategy evaluation server may calculate Max Percentage Win by using the following formula: ((Pmax−Open Price)/(Open Price))−1, and Max Absolute Win by using the following formula: (Pₘₐₓ−Open price). A Worst Percentage Loss may then be calculated by using the following formula: ((Pₘᵢₙ−Open Price)/(Open Price))−1, and a Max Absolute Loss may be calculated by using the following formula: (Pₘᵢₙ−Open price).

The strategy evaluation server may then measure a distribution of the following values for the trade turnarounds of the financial strategy 110a-c that is being evaluated: Percentage Win and Absolute Win for winning trade turnarounds, Percentage Loss and Absolute Loss for losing trade turnarounds, Max Percentage Win−Percentage Win, Worst Percentage Loss−Percentage Loss, Absolute Value of (Worst Percentage Loss−Percentage Loss) for losing trade turnarounds, and Absolute Value of (Worst Absolute Loss−Absolute Loss). This information (i.e., distributions of the measures described above) may then be used by the strategy evaluation server to calculate the discipline performance parameter in a manner that rewards distributions with low dispersion of close prices vs. maximum prices and distributions with low dispersion of actual loss vs. worst loss. A high discipline performance parameter score may indicate an enforcement of discipline in closing positions.

### Calculating Performance Scores

In order to calculate performance the strategy evaluation server may compile and aggregate (e.g., add, multiple, weight, and/or otherwise combine) of one or more of the performance parameter scores discussed above to determine an overall performance score 185 (denoted as PSn, where n denotes a particular strategy) for each financial trading strategy 110a-c at step 160. In one embodiment, each individual performance parameter score 180 (denoted as Sn-m, where n denotes a particular strategy and m denotes a particular performance parameter) may be converted into a score of 1-10 and then combined to provide the overall performance score 185 for each financial trading strategy 110a-c. For example, Strategy 1 (110a) may have a performance score PS₁ based on the parameter scores S₁₋₁ though S₁₋ₘ. While, Strategy N (110c) may have a performance score PSn based on the parameter scores Sₙ₋₁ though Sₙ₋ₘ. As noted above, the strategy evaluation server may apply any desired transformations and/or relative weightings to each of the performance parameter scores 180 as part of calculating the overall performance scores 185. In one embodiment, the values of the performance scores 180 may scaled to yield an overall performance Score 185 in the range of between 0-100 for each financial trading strategy 110a-c. Notably the individual performance scores 180 may be used (apart from the overall performance scores 185) to compare the trading strategies 110a-c on a parameter-by-parameter basis.

### Dynamic Calibrations of the Combined Performance Scores

Optionally, the strategy evaluation server may calibrate the combined performance scores at step 195 for all financial trade strategies 110a-c by, for example, regressing ex-post risk adjusted performance for financial trade strategies 110a-c against previously predicted performance scores. This may be accomplished, for example, by retrieving (either from an external source or from storage) previously determined ex-post performance parameter scores and risk metrics in a recent sequence of standardized time periods, and/or combined performance scores (of the strategies 110a-c) as of the same standardized time periods, and then generating a regression curve by regressing the combined performance scores against each of the individual performance parameter scores. Known advanced econometric techniques may be deployed for this regression. If the resulting parameters (i.e., points on the regression curve) are different from previous calibrations for the combined performance scores at a sufficiently high statistically significance level, the calibration of the combined performances score may be adapted accordingly.

### Financial Strategy Evaluation Exemplary System

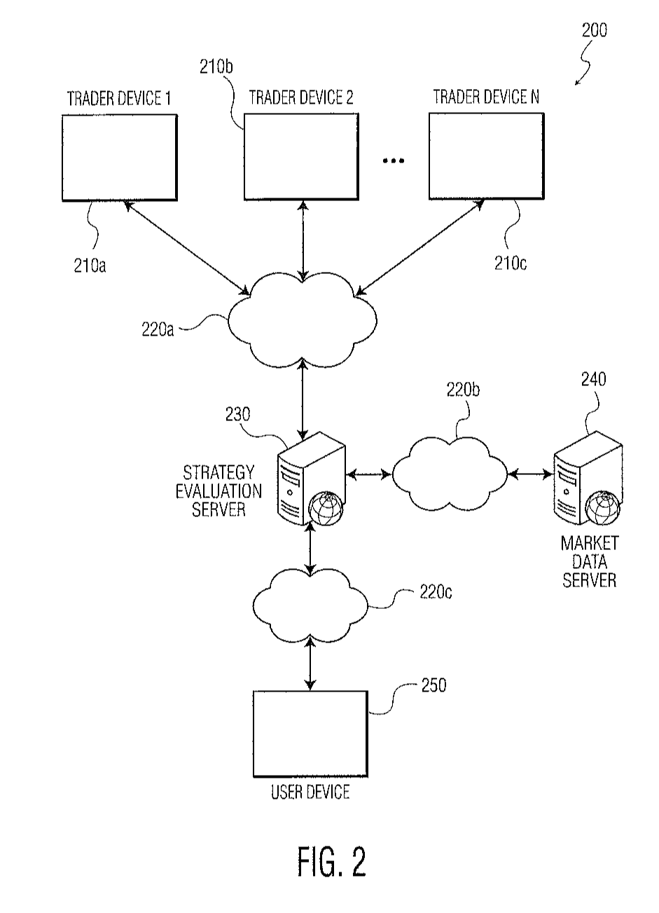

Turning now to FIG. 2, an exemplary system 200 for evaluating financial trading strategies in accordance with the present disclosure is shown. The system 200 comprises a strategy evaluation server 230, a market data server 240, one or more trader devices 210a-210c and one or more user devices 250. The exemplary system 200 may comprise an arbitrary number of trader devices 210a-210c and/or user devices 250, each of which may comprise one or more computing de-vices configured to store and/or execute computer-readable instructions. Similarly each of the strategy evaluation server 230 and the market data server 240 may also comprise one or more computing devices that include non-transitory memory for storing computer-readable instructions and a processor for executing the instructions.

The strategy evaluation server 230, the market data server 240, the trader devices 210a-210c and the user device(s) 250 may communicate with each other over one or more networks 220a, 220b, 220c. The networks 220a, 220b, 220c may comprise the Internet, Wi-Fi connections, cellular networks or any other wired or wireless connection or network known in the art. Each of the trader devices 210a-210e and the user device(s) 250 may comprise a particular type of computing device, such as (without limitation) a desktop computer, a laptop computer, a smartphone or any other user device known in the art.

In operation, the strategy evaluation server 230 may be configured to receive a plurality of financial trading strategies from the trader devices 210a-210c. Each of the financial trading strategies may comprise a record of a sequence of trades. Each of the trader devices 210a-210c may be associated with one or more traders (and/or trading entity(ies)) who has carried out one or more financial trading strategies and wishes to submit said trading strategies for evaluation to the strategy evaluation server 230. The trader devices 210a-210c may transmit data and information defining the trade sequence record(s) associated with the financial trading strategies to the strategy evaluation server 230 periodically or at any desired or predetermined times. Alternatively, the trader devices 210a-210c may use an automated submission process to automatically and directly transmit the financial trading strategy data and information to the strategy evaluation server 230 (e.g., as the data and information is created and becomes available).

The strategy evaluation server 230 may further be configured to evaluate and assign a performance score to each of the received financial trading strategies using any of the techniques described above. The strategy evaluation server 230 may also be configured to receive market data from the market data server 240, which may be used to evaluate the received financial trading strategies. For example, the market data may provide information indicative of market conditions surrounding trading decisions made as part of one or more of the financial trading strategies. The market data may comprise information that is relevant to financial assets traded as part of the received financial trading strategies. The received market data may also comprise other types of data and information, such as depth of market, prevailing interest rates, and any other type of market data known in the art.

The strategy evaluation server 230 may further be configured to conduct a consistency check during which the prices of trades included in the financial trading strategies may be checked against market data. The strategy evaluation server 230 may further conduct an internal contingency check for each financial trading strategy by checking the equity record reconstructed from the trade sequences of the financial trading strategies using market data to determine the financial interest rates for leveraged trades. These checks May be conducted using the methods described above.

The strategy evaluation server 230 may further be configured to standardize and evaluate each financial trading strategy by determining a plurality of performance parameters. The performance parameters determined by strategy evaluation server 230 may include one or more of a transmission latency performance parameter, a market liquidity performance parameter, a standardized risk parameter, a standardized financial performance parameter, a consistent leverage performance parameter, a historical risk deviation performance parameter, a loss aversion performance parameter, an entry performance parameter, an exit performance parameter, a discipline performance e and any other parameter indicative of trade/trade-decision performance. The values of the performance parameters may be calculated using the methods described above. Optionally, weight adjustments may be applied to the determined performance parameters before determining a final performance score for each of the financial trading strategies.

Once a final performance score is determined for each of the financial trading strategies, the strategy evaluation server 230 may be configured to transmit the performance scores to the user device 250 for the user to evaluate and consider. Alternatively, the strategy evaluation server 230 may be configured to assess the final performance scores, rank the financial trading strategies and/or recommend a financial trading strategy based, at least in part, on the ranking. The recommendation may also be based on user preference criteria. In either case, the user(s) associated with the user device(s) 250 may be able to use the performance scores and other information provided by the strategy evaluation server 230 to make informed investment decisions.

### Financial Strategy Evaluation Exemplary Method

In an exemplary embodiment, an exemplary method of assessing a performance of a financial trading strategy may be implemented and/or executed via one or more computing devices in communication with one another (e.g., via a wired and/or wireless network). Each of these computing device(s) may include one or more processors and non-transitory memory storing computer-readable instructions. When executed, the computer-readable instructions may cause the one or more computing devices to perform one or more of the following steps in furtherance of exemplary method.

As an initial step, the exemplary method may include receiving a trade record comprising a sequence of trades associated with the financial trading strategy being assessed. This trade record may include data and information describing and defining one or more trades that have been executed over a particular period of time, such as the date, time, price, volume, counterparties, financial instrument, leverage, etc. for each trade included in the trade record.

Once the trade record is received, the data and information defining the sequence of trades may be processed and analyzed to determine one or more performance parameters associated with at least one of the sequence of trades. For a particular trade in the sequence, the performance parameters may be based on financial data captured at a time of execution of the trade, or at a time other than a time of execution of the trade (e.g., at a time before and/or after execution of the trade). As further discussed below, these performance parameters may include any metric deemed appropriate for measuring the performance or quality of a particular trade. For example, performance parameters may include (without limitation) transmission latency, liquidity performance, standardized risk, standardized financial performance, consistent leverage performance, historical risk deviation performance, loss aversion performance, trade entry and exit performance, discipline performance, and/or any other performance metric.

After one or more of the performance parameters are determined, the exemplary method may include calculating an overall performance score based on the one or more performance parameters. This performance score may then be compared to performance scores of other trade records of other trading strategies to assess their relative performance (further described below).

Optionally, the exemplary method may include converting financial positions generated by the sequence of trades to standardized financial positions. This standardization may be based one or more of: a duration of time that a plurality of financial assets are placed at risk as a result of at least one trade of the sequence of trades, an observed volatility of the financial assets placed at risk, and a correlation between at least two of the plurality of financial assets that were at risk at the same time. A financial asset may be deemed “at risk” during the time it is being held waiting to be sold.

In order to evaluate the performance of one particular trading strategy against another on an ‘apples-to-apples’ basis, the exemplary method may further include receiving a second trade record comprising a second sequence of trades associated with at least one other financial trading strategy. The financial positions generated by this second sequence of trades may then be converted to standardized financial positions, so as to be comparable to the standardized financial positions from the first trading strategy described above. Once the financial positions of this second trading strategy are standardized, the exemplary method may include calculating a performance score of the second trade record based on one or more performance parameters associated one or more trades of this second sequence of trades. This performance score may then be compared to the performance score of first (or any other) trade record described above to determine their relative performance. Since the financial positions of both the first and second trading records were standardized, the resulting performance score yields an ‘apples-to-apples’ comparison.

As indicated above, the performance parameters used for measuring the performance and/or quality of trades may include and/or be based on any desired metric(s), including, for example, a transmission latency performance parameter. This performance parameter may generally be defined as a possible deviation in performance of a financial trading strategy due to potential time-delays in execution of each trade included in that financial trading strategy. Calculating this transmission latency performance parameter may include constructing a slipped price distribution based on: a price of at least one financial asset associated with at least one trade (in a sequence of trades included in a trading strategy) at a time of execution of that trade; and on a price or that (at least one) financial asset after a set delays following the time of execution. For purposes of this disclosure, a slipped price refers to a distribution of prices of the financial asset after a set of increasing delays.

A second exemplary performance parameter in accordance with the present disclosure may include a market liquidity performance parameter, which may generally be defined as a possible deviation in performance of a financial trading strategy due to a lack of liquidity in the market that prevents the trading strategy from being carried out at higher volumes. Determining this performance parameter may include calculating a plurality of hypothetical execution prices associated with at least one trade of the sequence of trades based on hypothetical increases in a trade volume of that (at least one) trade.

Another exemplary performance parameter may include a standardized risk parameter, which may generally be defined as a distribution of mark-to-market values of equity when a financial trading strategy places financial assets at risk vs. times when no assets are placed at risk. Determining this performance parameter may include calculating a hi-variable distribution based on one or more factors. The two independent variables that may be used to calculate the bi-variable distribution may include, for example, a distribution of value of at least one financial asset at times when at least one financial asset is placed at risk as a result of at least one trade of a sequence of trades; and a proportion of time when no financial assets are placed at risk as a result of the (at least one) trade of the sequence of trades.

Yet another exemplary performance parameter in accordance with the present disclosure includes a standardized financial performance parameter, which may generally be defined as the overall profitability of a financial trading strategy adjusted by performance of comparable random strategies. Determining this performance parameter may include: calculating a raw financial performance parameter based on a difference in value of at least one financial asset at a time of execution of a first trade (of the sequence of trades) and at a time of execution of a second trade (of that sequence of trades); and adjusting the raw financial performance parameter based on a random performance test parameter and a random leverage test parameter. Calculating the random performance test parameter may include calculating a raw financial performance of at least one simulated alternative trade record, wherein volatility, leverage and duration distribution of the (at least one) simulated alternative trade record are comparable to volatility, leverage and duration distribution of an actual trade record being assessed. Calculating the random leverage test parameter may include calculating a raw financial performance of at least one simulated alternative trade record, wherein leverage of each trade of the (at least one) simulated alternative trade record is equal to an average leverage of the sequence of trades of the trade record being assessed. For purposes of this disclosure, a “raw” financial performance parameter may refer to profitability of the trade record.

A fifth exemplary performance parameter according to the present disclosure may include a consistent leverage performance parameter, which may generally be defined as a measure of the consistency of risk due to leveraged trades across a predefined time period. Determining this performance parameter may include: calculating a nominal leverage of at least one financial asset associated with at least one trade of a sequence of trades (of a financial trading strategy) at the time of execution of said trade(s); calculating volatility of the financial asset(s); and calculating a length of a trade time period when the financial asset(s) is/are placed at risk as a result of the trade(s) of the sequence of trades. Optionally, determining this consistent leverage performance parameter may further include generating a plot of the calculated nominal leverage values multiplied by the calculated volatility values against the calculated length of the trade time period.

A sixth exemplary performance parameter may include a historical risk deviation performance parameter, which may be generally defined as a measure of the historical risk achieved by a financial trading strategy across pre-determined time periods. Determining this performance parameter may include: calculating a standardized risk measure for each of a plurality of consecutive standardized time periods associated with the financial trading strategy being assessed; and calculating a rate of change of the standardized risk measure across the plurality of consecutive standardized time periods.

Another exemplary performance parameter may include a loss aversion performance parameter, which may be generally be defined as a measure of a trader's psychological aversion to loss who would be willing to take risk to achieve a comparable win. Determining this performance parameter may include calculating a maximum favorable excursion measure based on a price of at least one financial asset at the time of execution of at least one trade of the sequence of trades being assessed, and on a maximum price of the financial asset(s) during a time period when the financial asset(s) is/are placed at risk as a result of the trade(s) of the sequence of trades being assessed. The term “maximum favorable excursion” may refer to the difference between the maximum market price of a financial asset during a trade turnaround and the price of the financial asset at the opening of the trade turnaround divided by the price at the opening.

Once the maximum favorable excursion measure is calculated, a maximum adverse excursion measure, based on a price of the financial asset(s) at the time of execution of the trade(s) of the sequence of trades and a minimum price of the financial asset(s) during a time period when the financial asset(s) is/are placed at risk as a result of the trade(s) of the sequence of trades being assessed, may be calculated. For purposes of this disclosure, a “maximum adverse excursion measure” may be defined as the difference between the minimum market price of a financial asset during a trade turnaround and the price of the financial asset at the opening of the trade turnaround divided by price at the opening.

Next, a trade bias distribution based on a ratio of the maximum favorable excursion and the maximum adverse excursion over a predetermined time period may be calculated. A “trade bias” distribution refers to a visual presentation (e.g., a histogram plot) of all trade biases for all trade turnarounds of a given financial trading strategy.

Still another exemplary performance parameter according to this disclosure may include an entry performance parameter and an exit performance parameter. An entry performance parameter may generally be defined as a measure of the extent to which a trade entry decision is optimal in view of market conditions, and an exit performance parameter may generally be defined as a measure the extent to which a trade exit decision is optimal in view of market conditions. Determining these performance parameters may include the steps of: calculating a first plurality of time windows during a time period when at least one financial asset is placed at risk as a result of at least one trade; calculating a second plurality of time windows during a time period before the financial asset(s) is/are placed at risk as a result of the trade(s); calculating a third plurality of time windows during a time period after the financial asset(s) is/are placed at risk as a result of the trade(s); and determining a prevailing price of the financial asset(s) during each of the first, second and third plurality of time windows.

As for calculating the entry performance parameter, these steps may further include ranking a price of financial asset(s) at the time of execution of at least one trade against at least one of the determined prevailing prices during the first and the second plurality of time windows; and calculating an entry ratio based on the price of the financial asset(s) at the time of execution of the trade(s) and a minimum and maximum values of the determined prevailing prices during the first and the second plurality of time windows.

As for calculating the exit performance parameter, these steps may further include ranking a price of at least one financial asset at the time of execution of at least one trade (of a sequence of trades) against at least one of the determined prevailing prices during the first and the third plurality of time windows; and calculating an exit ratio based on the price of the financial asset(s) at the time of execution of the trade(s) and a minimum and maximum values of the determined prevailing prices during the first and the third plurality of time windows.

A ninth exemplary performance parameter in accordance with this disclosure may include a discipline performance parameter, which may generally be defined as a measure of dispersion between trade turnaround closing prices of a financial asset and the maximum prices of the financial asset during the trade turnaround. Determining this performance parameter may include the steps of calculating a win/loss measure for a time period when at least one financial asset is placed at risk as a result of at least one trade. For purposes of this disclosure, a “win/loss” measure may refer to the difference or disparity of a trade turnaround closing price and the trade turnaround opening price. Once the win/loss measure is calculated, a maximum and a minimum price of the one financial asset(s) during the time period may be determined. Then, a maximum win/loss measure and a minimum win/loss measure for the time period based on the maximum and the minimum prices and a price of the financial asset at the time of execution of the trade(s) may be calculated.

After one or more performance parameters are determined, a performance score (based at least in part of the performance parameter scores) may be calculated for a trade record that defines a financial trading strategy. Calculating this performance score may include calculating weight adjustments for each of the determined performance parameters, applying these weight adjustments to the various performance parameter scores, and then calculating the overall performance score based on the weight-adjusted scores of each of the performance parameters. As noted above, this overall performance score may then be compared to other performance scores to determine their respective relative performance.

### Financial Strategy Evaluation Exemplary System

An exemplary system for assessing the performance of one or more financial trading strategies and providing the results to one or more users may include one or more computing devices in communication with one another (e.g., via one or more wired and/or wireless networks). Each of these computing devices may include one or more processors and non-transitory memory storing computer-readable instructions that, when executed, cause said the computing device(s) perform one or more of the performance assessment steps described throughout this disclosure.

In operation, the exemplary system may be configured to receive one or more trade records, each comprising a sequence of trades associated with the financial trading strategy being assessed. These trade records may be received from one or more computing devices (e.g., a trader device) in communication with the exemplary system via a wired and/or wireless network. As noted above, each received trade record may include data and information describing and defining one or more trades that have been executed over a particular period of time, such as the date, time, price, volume, counterparties, financial instrument, etc. [Max, any other data and information we should include here?]

Once a trade record is received, the exemplary system may execute computer-readable instructions to process and analyze the data and information defining the sequence of trades to determine one or more performance parameters associated with at least one of the trades. For a particular trade in the sequence, the performance parameters may be based on financial data captured at a time of execution of the trade, or at a time other than a time of execution of the trade (e.g., at a time before and/or after execution of the trade). As previously explained, the performance parameters may include any metric deemed appropriate for measuring the performance or quality of a particular trade. As such, the exemplary system may be configured to determine one or more performance parameters, including (without limitation) transmission latency, liquidity performance, standardized risk, standardized financial performance, consistent leverage performance, historical risk deviation performance, loss aversion performance, trade entry and exit performance, discipline performance, and/or any other performance metric, for any number of trades and in the manner described above.

After one or more of the performance parameters are determined for one or more trades in the trade sequence, the exemplary system may execute computer-readable instructions that cause it to calculate an overall performance score for the trade record. This overall performance score may be based, at least in part, on the one or more performance parameter scores previously determined. This performance score may then be provided (e.g., transmitted) to a user via, for example, a user device that is in communication with said exemplary system (via a wired and/or a wireless network) for comparison against other trade record performance scores; and/or the exemplary system may be configured to assess and calculate a performance score for multiple trade records (e.g., from one or more trading devices), compare the performance scores, identify a preferred financial trading strategy based on said comparison and provide such information to a user.

In order to calculate the performance score of any particular trade record, the exemplary system may execute computer-readable instructions that cause it to calculate weight adjustments for each of the determined performance parameters, apply these weight adjustments to the various performance parameter scores, and then calculate the overall performance score by compiling the weight-adjusted scores of each of the performance parameters. As noted above, this overall performance score may then be compared to other performance scores to determine their respective relative performance.

Optionally, if a particular trade record includes a sequence of trades involving different types of financial assets, or if there is a desire to compare multiple trade records involving diverse financial assets, the exemplary system may execute computer-readable instructions that cause it to convert financial positions generated by (or resulting from) trades in the trade record(s) into standardized financial positions in the manner described above (or according to any standardization model). Once the financial positions are standardized, the exemplary system may proceed to determine performance parameter(s), weight the performance parameter(s) and/or calculate an overall performance score for any number of trade records. These overall performance scores may then be used to compare the trade record(s) on an ‘apples-to-apples’ basis, as noted above.

While certain embodiments have been described above, it will be understood that the embodiments described are by way of example only. Accordingly, the present disclosure should not be limited based on the described embodiments. Rather, the scope of the present disclosure should only be limited in light of the claims that follow when taken in conjunction with the above description and accompanying drawings.

1. A method for assessing performance of a financial trading strategy, the method comprising:
receiving, by at least one computing device, a trade record comprising a sequence of trades associated with the financial trading strategy;
determining, by the at least one computing device, one or more performance parameters associated with at least one trade of the sequence of trades, wherein at least one of the one or more performance parameters is based on financial data captured at a time other than a time of execution of the at least one trade of the sequence of trades; and
calculating, by the at least one computing device, a performance score of the trade record based on the one or more performance parameters.

2. The method of claim 1, wherein at least one of the one or more performance parameters is based on financial data captured at the time of execution of the at least one trade of the sequence of trades.

3. The method of claim 1, further comprising:
converting financial positions generated by the sequence of trades to standardized financial positions, wherein the standardized financial positions are based on a duration of time that a plurality of financial assets are placed at risk as a result of the at least one trade of the sequence of trades, an observed volatility of the plurality of the financial assets placed at risk, and a correlation between at least two of the plurality of financial assets that were at risk simultaneously.

4. The method of claim 3, further comprising:
receiving a second trade record comprising a second sequence of trades associated with at least one other financial trading strategy;
converting financial positions generated by the second sequence of trades of the second trade record to standardized financial positions;
calculating a performance score of the second trade record based on one or more performance parameters associated with at least one trade of the second sequence of trades; and
comparing the performance score of the trade record with the performance score of the second trade record.

5. The method of claim 1, wherein the one or more performance parameters comprises a transmission latency performance parameter, wherein calculating the transmission latency performance parameter comprises:
constructing a slipped price distribution based on a price of at least one financial asset associated with the at least one trade of the sequence of trades at the time of execution of the at least one trade of the sequence of trades and a price of the at least one financial asset after a set delay following the time of execution.

6. The method of claim 1, wherein the one or more performance parameters comprises a market liquidity performance parameter, wherein calculating the market liquidity performance parameter comprises:
calculating a plurality of hypothetical execution prices associated with at least one trade of the sequence of trades based on hypothetical increases in a trade volume of the at least one trade.

7. The method of claim 1, wherein the one or more performance parameters comprises a standardized risk parameter, wherein calculating the standardized risk parameter comprises:
calculating a hi-variable distribution based on:
a distribution of value of at least one financial asset at times when the at least one financial asset is placed at risk as a result of the at least one trade of the sequence of trades; and
a proportion of time when no financial assets are placed at risk as a result of the at least one trade of the sequence of trades.

8. The method of claim 1, wherein the one or more performance parameters comprises a standardized financial performance parameter, wherein calculating the standardized financial performance parameter comprises:
calculating a raw financial performance parameter based on a difference in value of at least one financial asset at a time of execution of a first trade of the sequence of trades and at a time of execution of a second trade of the sequence of trades; and
adjusting the raw financial performance parameter based on a random performance test parameter and a random leverage test parameter.

9. The method of claim 8, wherein calculating the random performance test parameter comprises:
calculating a raw financial performance of at least one simulated alternative trade record, wherein volatility, leverage and duration distribution of the at least one simulated alternative trade record are comparable to volatility, leverage and duration distribution of the trade record.

10. The method of claim 8, wherein calculating the random leverage test parameter comprises:
calculating a raw financial performance of at least one simulated alternative trade record, wherein leverage of each trade of the at least one simulated alternative trade record is equal to an average leverage of the sequence of trades of the trade record.

11. The method of claim 1, wherein the one or more performance parameters comprises a consistent leverage performance parameter, wherein calculating the consistent leverage performance parameter comprises:
calculating a nominal leverage of at least one financial asset associated with the at least one trade of the sequence of trades at the time of execution of the at least one trade;
calculating volatility of the at least one financial asset; and
calculating a length of a trade time period when the at least one financial asset is placed at risk as a result of the at least one trade of the sequence of trades.

12. The method of claim 11, wherein calculating the consistent leverage performance parameter further comprises:
generating a plot of the calculated nominal leverage values multiplied by the calculated volatility values against the calculated length of the trade time period.

13. The method of claim 1, wherein the one or more performance parameters comprises a historical risk deviation performance parameter, wherein calculating the historical risk deviation performance parameter comprises:
calculating a standardized risk measure for each a plurality of consecutive standardized time periods associated with the financial trading strategy; and
calculating a rate of change of the standardized risk measure across the plurality of consecutive standardized time periods.

14. The method of claim 1, wherein the one or more performance parameters comprises a loss aversion performance parameter, wherein calculating the loss aversion performance parameter comprises:
calculating a maximum favorable excursion measure based on a price of at least one financial asset at the time of execution of the at least one trade of the sequence of trades and a maximum price of the at least one financial asset during a time period when the at least one financial asset is placed at risk as a result of the at least one trade of the sequence of trades;
calculating a maximum adverse excursion measure based on a price of the at least one financial asset at the time of execution of the at least one trade of the sequence of trades and a minimum price of the at least one financial asset during a time period when the at least one financial asset is placed at risk as a result of the at least one trade of the sequence of trades; and
calculating a trade bias distribution based on a ratio of the maximum favorable excursion and the maximum adverse excursion over a predetermined time period.

15. The method of claim 1, wherein the one or more performance parameters comprises an entry performance parameter and an exit performance parameter, wherein calculating the entry and exit performance parameters comprises:
calculating a first plurality of time windows during a time period when at least one financial asset is placed at risk as a result of the at least one trade of the sequence of trades;
calculating a second plurality of time windows during a time period before the at least one financial asset is placed at risk as a result of the at least one trade of the sequence of trades;
calculating a third plurality of time windows during a time period after the at least one financial asset is placed at risk as a result of the at least one trade of the sequence of trades; and
determining a prevailing price of the at least one financial asset during each of the first, second and third plurality of time windows.

16. The method of claim 15, wherein calculating the entry performance parameter further comprises:
ranking a price of the at least one financial asset at the time of execution of the at least one trade of the sequence of trades against at least one of the determined prevailing prices during the first and the second plurality of time windows; and
calculating an entry ratio based on the price of the at least one financial asset at the time of execution of the at least one trade of the sequence of trades and a minimum and maximum values of the determined prevailing prices during the first and the second plurality of time windows.

17. The method of claim 15, wherein calculating the exit performance parameter further comprises:
ranking a price of the at least one financial asset at the time of execution of the at least one trade of the sequence of trades against at least one of the determined prevailing prices during the first and the third plurality of time windows; and
calculating an exit ratio based on the price of the at least one financial asset at the time of execution of the at least one trade of the sequence of trades and a minimum and maximum values of the determined prevailing prices during the first and the third plurality of tune windows.

18. The method of claim 1, wherein the one or more performance parameters comprises a discipline performance parameter, wherein calculating the discipline performance parameter comprises:
calculating a win/loss measure for a time period when at least one financial asset is placed at risk as a result of the at least one trade of the sequence of trades;
determining a maximum and a minimum price of the at least one financial asset during the time period; and
calculating a maximum win/loss measure and a minimum win/loss measure for the time period based on the maximum and the minimum prices and a price of the financial asset at the time of execution of the at least one trade of the sequence of trades.

19. The method of claim 1, wherein calculating the performance score of the trade record further comprises:
calculating weight adjustments for each of the one or more performance parameters; and
calculating the performance score based on a weight-adjusted score of each of the one or more performance parameters.

20. A system for assessing performance of a financial trading strategy, the system comprising one or more computing devices in communication with one another via at least one of a wired and wireless network, each of said computing devices comprising one or more processors and non-transitory memory storing computer-readable instructions that when executed cause said one or more computing devices to:
receive a trade record comprising a sequence of trades associated with the financial trading strategy;
determine one or more performance parameters associated with at least one trade of the sequence of trades, wherein at least one of the one or more performance parameters is based on financial data captured at a time other than a time of execution of the at least one trade of the sequence of trades; and
calculate a performance score of the trade record based on the one or more performance parameters.

21. The system of claim 20, wherein at least one of the one or more performance parameters is based on financial data captured at the time of execution of the at least one trade of the sequence of trades.

22. The system of claim 20, wherein the computer-readable instructions, when executed, further cause said one or more computing devices to:
convert financial positions generated by the sequence of trades to standardized financial positions, wherein the standardized financial positions are based on a duration of time that a plurality of financial assets are placed at risk as a result of the at least one trade of the sequence of trades, an observed volatility of the plurality of the financial assets placed at risk, and a correlation between at least two of the plurality of financial assets that were at risk simultaneously.

23. The system of claim 22, wherein the computer-readable instructions, when executed, further cause said one or more computing devices to:
receive a second trade record comprising a second sequence of trades associated with at least one other financial trading strategy;
convert financial positions generated by the second sequence of trades of the second trade record to standardized financial positions;
calculate a performance score of the second trade record based on one or more performance parameters associated with at least one trade of the second sequence of trades; and
compare the performance score of the trade record with the performance score of the second trade record.

24. The system of claim 20, wherein the one or more performance parameters comprises a transmission latency performance parameter, and wherein said system is further configured to calculate the transmission latency performance parameter by executing computer-readable instructions that cause said one or more computer devices to:
construct a slipped price distribution based on a price of at least one financial asset associated with the at least one trade of the sequence of trades at the time of execution of the at least one trade of the sequence of trades and a price of the at least one financial asset after a set delay following the time of execution.

25. The system of claim 20, wherein the one or more performance parameters comprises a market liquidity performance parameter, and wherein said system is further configured to calculate the market liquidity performance parameter by executing computer-readable instructions that cause said one or more computer devices to:
calculate a plurality of hypothetical execution prices associated with at least one trade of the sequence of trades based on hypothetical increases in a trade volume of the at least one trade.

26. The system of claim 20, wherein the one or more performance parameters comprises a standardized risk parameter, and wherein said system is further configured to calculate the standardized risk parameter by executing computer-readable instructions that cause said one or more computer devices to:
calculate a bi-variable distribution based on:
a distribution of value of at least one financial asset at times when the at least one financial asset is placed at risk as a result of the at least one trade of the sequence of trades; and
a proportion of time when no financial assets are placed at risk as a result of the at least one trade of the sequence of trades.

27. The system of claim 20, wherein the one or more performance parameters comprises a standardized financial performance parameter, and wherein said system is further configured to calculate the standardized financial performance parameter by executing computer-readable instructions that cause said one or more computer devices to:
calculate a raw financial performance parameter based on a difference in value of at least one financial asset at a time of execution of a first trade of the sequence of trades and at a time of execution of a second trade of the sequence of trades; and
adjust the raw financial performance parameter based on a random performance test parameter and a random leverage test parameter.

28. The system of claim 27, wherein said system is configured to calculate the random performance test parameter by executing computer-readable instructions that cause said one or more computer devices to:
calculate a raw financial performance of at least one simulated alternative trade record, wherein volatility, leverage and duration distribution of the at least one simulated alternative trade record are comparable to volatility, leverage and duration distribution of the trade record.

29. The system of claim 27, wherein said system is configured to calculate the random leverage test parameter by executing computer-readable instructions that cause said one or more computer devices to:
calculate a raw financial performance of at least one simulated alternative trade record, wherein leverage of each trade of the at least one simulated alternative trade record is equal to an average leverage of the sequence of trades of the trade record.

30. The system of claim 20, wherein the one or more performance parameters comprises a consistent leverage performance parameter, and wherein said system is further configured to calculate the consistent leverage performance parameter by executing computer-readable instructions that cause said one or more computer devices to:
calculate a nominal leverage of at least one financial asset associated with the at least one trade of the sequence of trades at the time of execution of the at least one trade;
calculate volatility of the at least one financial asset; and
calculate a length of a trade time period when the at least one financial asset is placed at risk as a result of the at least one trade of the sequence of trades.

31. The system of claim 30, wherein the system is configured to calculate the consistent leverage performance parameter further by executing computer-readable instructions that cause said one or more computer devices to:
generate a plot of the calculated nominal leverage values multiplied by the calculated volatility values against the calculated length of the trade time period.

32. The system of claim 20, wherein the one or more performance parameters comprises a historical risk deviation performance parameter, and wherein said system is further configured to calculate the historical risk deviation performance parameter by executing computer-readable instructions that cause said one or more computer devices to:
calculate a standardized risk measure for each a plurality of consecutive standardized time periods associated with the financial trading strategy; and
calculate a rate of change of the standardized risk measure across the plurality of consecutive standardized time periods.

33. The system of claim 20, wherein the one or more performance parameters comprises a loss aversion performance parameter, and wherein said system is further configured to calculate the loss aversion performance parameter by executing computer-readable instructions that cause said one or more computer devices to:
calculate a maximum favorable excursion measure based on a price of at least one financial asset at the time of execution of the at least one trade of the sequence of trades and a maximum price of the at least one financial asset during a time period when the at least one financial asset is placed at risk as a result of the at least one trade of the sequence of trades;
calculate a maximum adverse excursion measure based on a price of the at least one financial asset at the time of execution of the at least one trade of the sequence of trades and a minimum price of the at least one financial asset during a time period when the at least one financial asset is placed at risk as a result of the at least one trade of the sequence of trades; and
calculate a trade bias distribution based on a ratio of the maximum favorable excursion and the maximum adverse excursion over a predetermined time period.

34. The system of claim 20, wherein the one or more performance parameters comprises an entry performance parameter and an exit performance parameter, and wherein said system is further configured to calculate the entry and exit performance parameters by executing computer-readable instructions that cause said one or more computer devices to:
calculate a first plurality of time windows during a time period when at least one financial asset is placed at risk as a result of the at least one trade of the sequence of trades;
calculate a second plurality of time windows during a time period before the at least one financial asset is placed at risk as a result of the at least one trade of the sequence of trades;
calculate a third plurality of time windows during a time period after the at least one financial asset is placed at risk as a result of the at least one trade of the sequence of trades; and
determine a prevailing price of the at least one financial asset during each of the first, second and third plurality of time windows.

35. The system of claim 34, wherein the system is configured to calculate the entry performance parameter further by executing computer-readable instructions that cause said one or more computer devices to:
rank a price of the at least one financial asset at the time of execution of the at least one trade of the sequence of trades against at least one of the determined prevailing prices during the first and the second plurality of time windows; and
calculate an entry ratio based on the price of the at least one financial asset at the time of execution of the at least one trade of the sequence of trades and a minimum and maximum values of the determined prevailing prices during the first and the second plurality of time windows.

36. The system of claim 34, wherein the system is configured to calculate the exit performance parameter further by executing computer-readable instructions that cause said one or more computer devices to:
rank a price of the at least one financial asset at the time of execution of the at least one trade of the sequence of trades against at least one of the determined prevailing prices during the first and the third plurality of time windows; and
calculate an exit ratio based on the price of the at least one financial asset at the time of execution of the at least one trade of the sequence of trades and a minimum and maximum values of the determined prevailing prices during the first and the third plurality of time windows.

37. The system of claim 20, wherein the one or more performance parameters comprises a discipline performance parameter, and wherein said system is further configured to calculate the discipline performance parameter by executing computer-readable instructions that cause said one or more computer devices to:
calculate a win/loss measure for a time period when at least one financial asset is placed at risk as a result of the at least one trade of the sequence of trades;
determine a maximum and a minimum price of the at least one financial asset during the time period; and
calculate a maximum win/loss measure and a minimum win/loss measure for the time period based on the maximum and the minimum prices and a price of the financial asset at the time of execution of the at least one trade of the sequence of trades.

38. The system of claim 20, wherein said system is configured to calculate the performance score of the trade record further by executing computer-readable instructions that cause said one or more computer devices to:
calculate weight adjustments for each of the one or more performance parameters; and
calculate the performance score based on a weight-adjusted score of each of the one or more performance parameters.
